(19) United States
(12) Patent Application Publication
(10) Pub. No.: US 2012/0149362 A1
(43) Pub. Date: Jun. 14, 2012

(54) Victim User Equipment Status

(75) Inventors: J. Patrick Tooher, Montreal (CA); Pascal M. Adjakple, Great Neck, NY (US); Guodong Zhang, Syosset, NY (US); Afshin Haghighat, lle-Bizard (CA); Mahmoud Watfa, Saint Leonard (CA); Ulises Olvera-Hernandez, Kirkland (CA)

(73) Assignee: InterDigital Patent Holdings, Inc., Wilmington, DE (US)

(21) Appl. No.: 13/162,929

(22) Filed: Jun. 17, 2011

Related U.S. Application Data
(60) Provisional application No. 61/356,417, filed on Jun. 18, 2010.

(51) Int. Cl. H04W 24/00

(52) U.S. Cl. 455/423

(57) ABSTRACT

Methods are presented wherein a WTRU may determine, based on measurements, that it is a victim of interference from another cell such a closed subscriber group (CSG) cell. In addition, methods are presented for the UE to inform the CSG cell that UE is present and is a victim UE. Methods for informing the CSG cell may include the grant of temporary membership to a victim UE, the use of a connected WTRU as a relay, and/or indicating victim status in a control message. The indication may trigger an interference management procedure. Methods for the WTRU to stop interference management at the CSG cell, methods to allow the use of a training period by the CSG eNB to allow for non-CSG WTRUs to report their presence, and methods to indicate how to perform UE Victim Indication are also presented.

### CROSS REFERENCE TO RELATED APPLICATIONS

This application claims the benefit of U.S. Provisional Patent Application No. 61/356,417 filed Jun. 18, 2010, the contents of which are hereby incorporated by reference herein.

### BACKGROUND

The Third Generation Partnership Project (3GPP) Long Term Evolution (LTE) standards provide specifications for high performance air interfaces for cellular mobile communication systems. LTE specifications are based on Global System for Mobile Communications (GSM) specifications, and provide the upgrade path for 3G networks to evolve into partially-compliant 4G networks. LTE Advanced (LTE release 10) is an enhancement of the LTE standard that provides a fully-compliant 4G upgrade path for LTE and 3G networks.

With growing demand for data services, it is becoming increasingly difficult to meet the required data capacity through traditional cell-splitting techniques, which require deployment of more wide-area eNode B's (eNBs). LTE Advanced (LTE-A) allows for the deployment of low power nodes (e.g., relay nodes, low power pico eNBs, Home eNBs (HeNBs, closed subscriber group (CSG) cells, Femto Cells, etc.) within the range of eNBs, which can significantly improve capacity of the network at a cost-effective manner compared to traditional cell-splitting techniques. A network deployment incorporating one or more of the local-area range node categories listed above (besides wide-area eNBs) may be considered a heterogeneous network deployment. A Wireless Transmit/Receive Unit (WTRU) deployed in a heterogeneous network may be able to access both wide area nodes and low power nodes, or may have access to a subset of nodes/cells. Heterogeneous deployments may occur in both LTE and Universal Mobile Telecommunications System (UMTS) networks.

### SUMMARY

A method for a Wireless Transmit/Receive Unit (WTRU) to determine that it is a victim of inter-cell interference and trigger an inter cell interference management procedure are disclosed. The WTRU may receive transmissions from a first eNode B (eNB) which may correspond to a first cell. The WTRU may be connected to the first cell or may be camped on the first cell. The WTRU may determine that transmissions from a second eNB are causing interference with the transmissions from the first eNB. The WTRU may make the determination based on cell measurements, such as cell reselection measurements. A WTRU experiencing inter-cell interference may be a victim UE. The second eNB may correspond to a second cell and may be a CSG which the WTRU is unable to access or connect to. The WTRU may send a first message to at least one of the first eNB or the second eNB. The first message may indicate that the WTRU is experiencing interference and triggers a cell interference management procedure. The WTRU may periodically or aperiodically send updated cell measurements to the first eNB or the second eNB.

The WTRU may send indications to CSG cells for which it lacks membership by utilizing a grant of temporary membership to the CSG cell. The WTRU may also use of a connected WTRU as a relay to the CSG cell. The WTRU may also indicate its victim status in a control message such as a Radio Resource Control (RRC) message. The WTRU may trigger the end of the interference management procedure. The WTRU may make use of a training period announced by the CSG cell to report its presence and victim status. The cell interference management procedure may include at least one of power control, time-domain resource partitioning, frequency-domain resource portioning, or spatial beamforming.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an another example radio access network and an another example core network that may be used within the communications system illustrated in FIG. 1A;

FIG. 1E is a system diagram of an another example radio access network and an another example core network that may be used within the communications system illustrated in FIG. 1A;

FIG. 2 is a graphical representation of an example heterogeneous network in which inter-cell interference may occur;

FIG. 3 is a graphical representation of another example heterogeneous network in which inter-cell interference may occur; and

FIG. 4 is an example flow diagram of a WTRU initiated cell interference management procedure.

### DETAILED DESCRIPTION OF ILLUSTRATIVE EMBODIMENTS

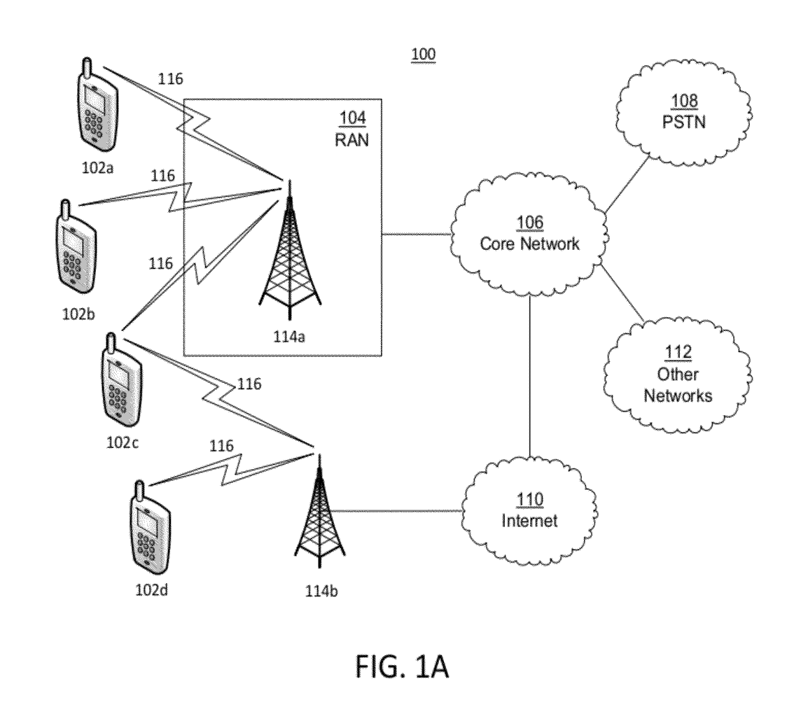

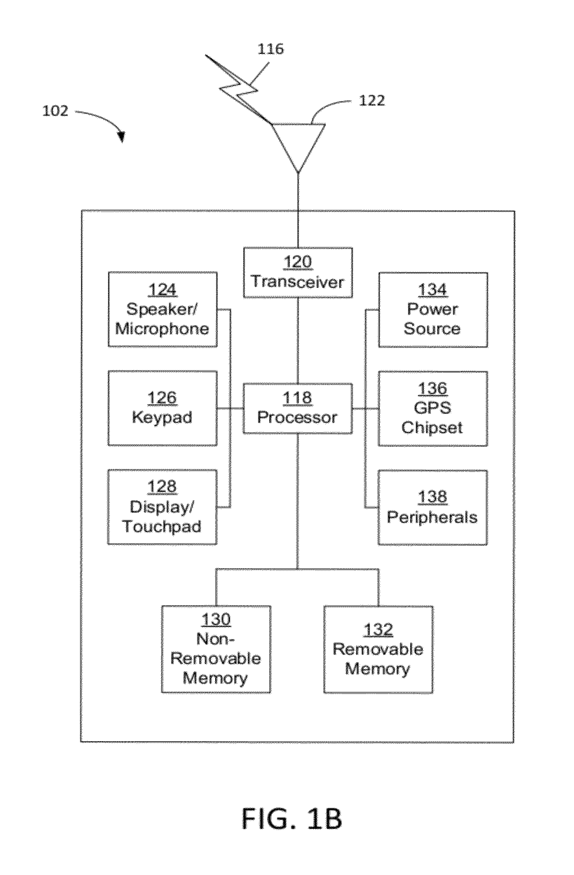

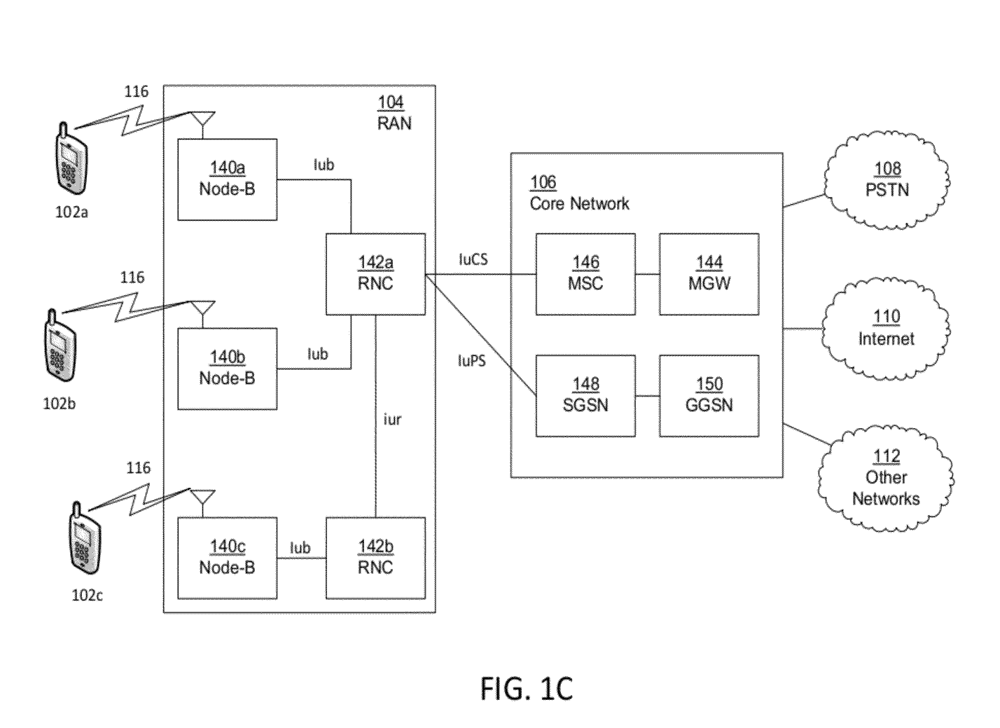

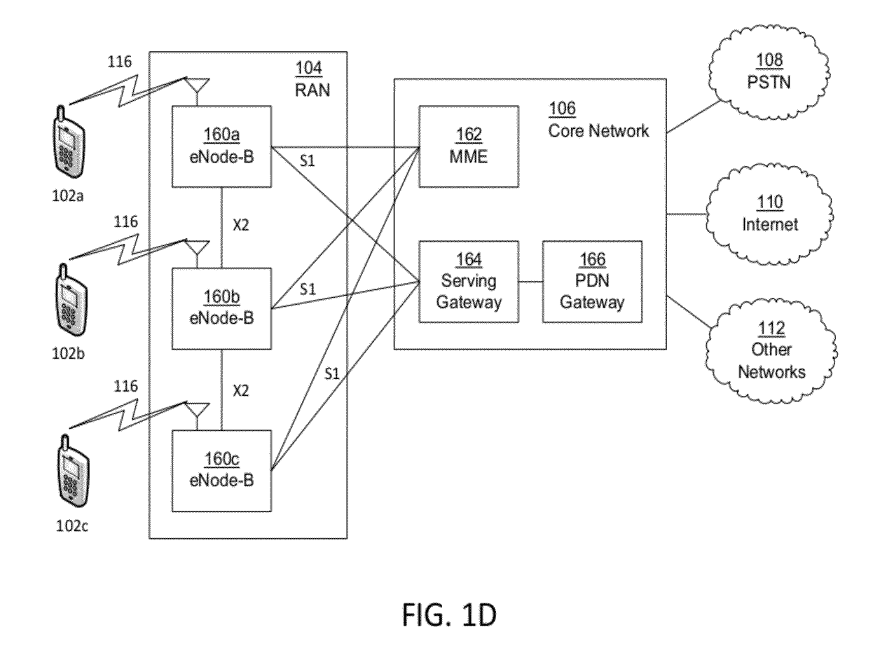

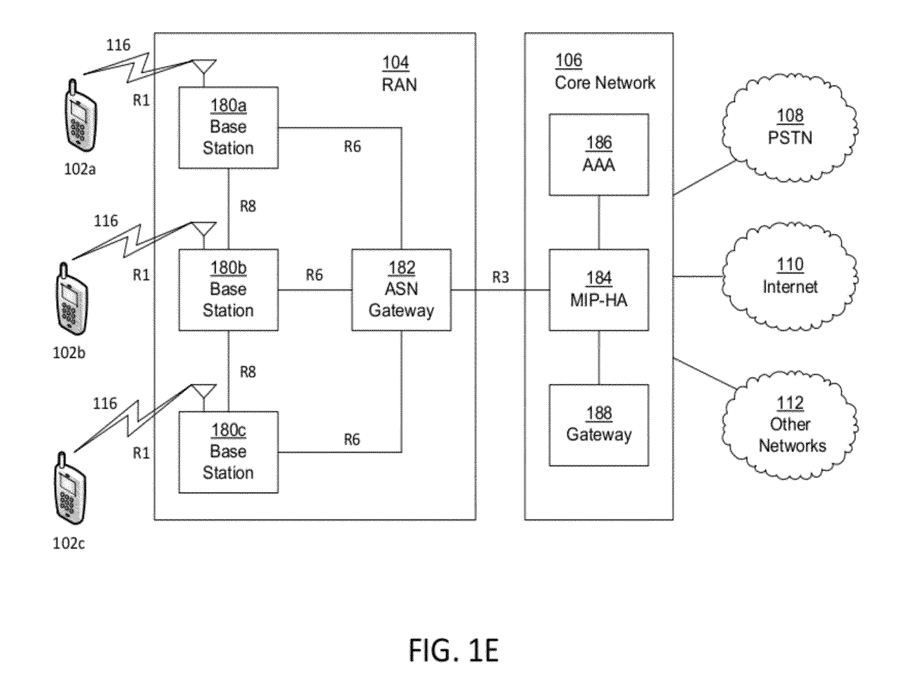

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA20001x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a pico cell or femto cell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 106 shown in FIG. 1D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 180a, 180b, 180c, and an ASN gateway 182, though it will be appreciated that the RAN 104 may include any number of base stations and ASN gateways while remaining consistent with an embodiment. The base stations 180a, 180b, 180c may each be associated with a particular cell (not shown) in the RAN 104 and may each include one or more transceivers for communicating with the WTRUs 102a, 102b, 102c over the air interface 116. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may be defined as an R3 reference point that includes protocols for facilitating data transfer and mobility management capabilities, for example. The core network 106 may include a mobile IP home agent (MIP-HA) 184, an authentication, authorization, accounting (AAA) server 186, and a gateway 188. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Enhanced Inter-Cell Interference Coordination (eICIC) may be implemented in order to control inter-cell interference, for example through the use of Radio Resource Management (RRM) methods. For example, eICIC may make use of non-carrier aggregation based ICIC within heterogeneous deployments. eICIC may be implemented in networks with heterogeneous cell deployments in order to allow WTRUs to properly receive downlink control channels. For example, as Femto Cell deployment becomes more prevalent, interference between Femto Cells and traditional macro cells may increase because femto cells may use the same frequency bands as macro cells in the same coverage area. Severe interference may be experienced by WTRUs that lack access to closed subscriber group (CSG) cells when the WTRU is in the vicinity of the eNB servicing the CSG cell. Due to the inability of the WTRUs to connect to CSG cells for which they lack access, interference management may be difficult to implement. Additionally, WTRUs in heterogeneous deployments may select less than optimal cells due to biased reference symbol received power (RSRP) based cell associations, for example when a femto cell is employing range expansion in the proximity of a macro cell eNB. Another exemplary inter-cell interference management technique may be Home NodeB Interference Management (HNIM). HNIM may be implemented in UMTS networks.

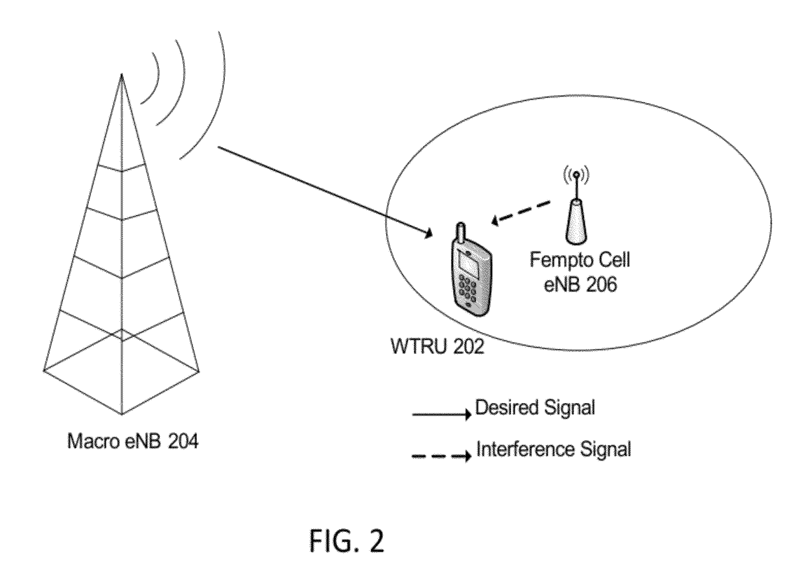

FIG. 2 illustrates an example cause of severe interference in a heterogeneous network. In this example, WTRU 202 may be attempting to access a cellular network. For example, WTRU 202 may be in the vicinity of Macro eNB 204, which may serve or correspond to a first network cell, and Femto Cell eNB 206, which may serve or correspond to a second network cell. Femto Cell eNB 206 may be deployed by individuals/entities other than network operators or may be deployed by a network operator, for example to increase coverage in an underserved network location. Femto Cell eNB 206 may be a smaller base station as compared to a typical eNB and may be designed for the use in a home or small business. Femto Cell eNB 206 may interface with the core network via a broadband connection (e.g., Digital Subscriber Line (DSL), cable lines, etc.) in addition to or in replacement for typical core network interfaces. In another example, Femto Cell eNB 206 may interface with the core network via dedicated interfaces (e.g., IUCS/IuPS interface of FIG. 1C, the 51 interface of FIG. 1D, the R3 interface of FIG. 1E, etc.). In an LTE network, Femto Cell eNB 206 may be called a Home eNodeB (HeNB). Femto Cell eNB 206 may serve a smaller area than a typical eNB, for example the range of Femto Cell eNB 206 may be 10-20 meters. In another example, interference may be caused by a Pico Cell eNB, which may have a range of approximately 200 meters.

WTRU 202 may be called a victim UE. A victim UE (or victim WTRU) may be a network subscriber/UE which is unable to properly send or receive control or user data via a network air interface due to interference caused by one or more cells not currently serving the WTRU. The interference may be caused by a CSG cell, and the victim UE may be unable to connect to the CSG. The victim UE may be unauthorized to connect to the CSG cell. For example, WTRU 202 may be unable to connect to Femto Cell eNB 206 because Femto Cell eNB 206 may serve a CSG cell for which WTRU 202 does not have permission to access. WTRU 202 may be unable to connect to Femto Cell eNB 206 despite the fact that Femto Cell eNB 206 may have a better Reference Signal Received Power (RSRP) than a Macro eNB 204. In this situation, frequency-use overlap between Macro eNB 204 and Femto Cell eNB 206 may cause WTRU 202 to be unable to successfully receive the desired signal from Macro eNB 204.

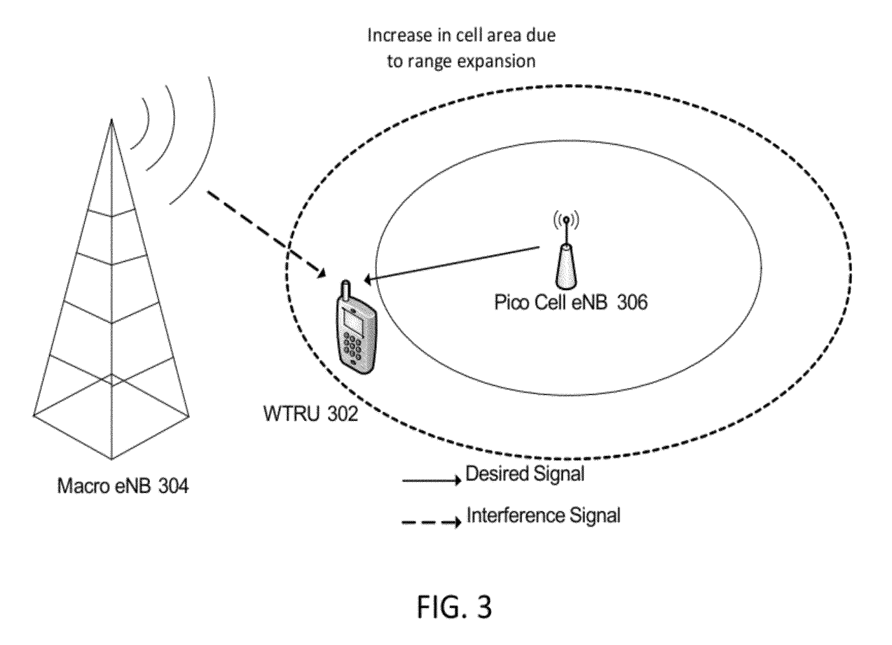

In another example, as shown in FIG. 3, a low power cell such as a pico cell or HeNB may employ range expansion in order to increase cell coverage/size. For example, Pico Cell eNB 306 may employ range expansion in order to provide a broader coverage area, thus allowing WTRU 302 to connect to Pico Cell eNB 306 at greater distances from the location of Pico Cell eNB 306. Range expansion may employ an offset to the RSRP measurements to increase the coverage area and further offload macro cells by allowing more WTRUs to select Pico Cell eNB 306. In this example, Pico Cell eNB may or may not serve or correspond to a CSG cell. WTRU 302 may be authorized to connect to Pico Cell eNB 306. As shown in FIG. 3, WTRU may be attempting to receive a signal sent from Pico Cell eNB 306, but may experience interference caused by a signal sent from Macro eNB 304. In this scenario, Macro eNB 304 may be called the aggressor eNB and/or aggressor cell. WTRU 302 may be classified as a victim UE. Example candidate technologies for interference management functions include power control (e.g., a Pico cell may adjust its output power to avoid interference), time-domain resource partitioning (e.g., subframe allocation may be coordinated between network nodes through backhaul signaling), frequency-domain resource portioning (e.g., orthogonal bandwidth may be used for control signaling and/or common information across neighboring nodes), spatial beamforming, and or a combination of the aforementioned methods.

In many situations, proposed eICIC and/or HNIM functions may be wasteful and unnecessary if there is no victim UE present. For example, blindly using resource partitioning in the example illustrated in FIG. 2 may cause a loss of performance if the resource partitioning is triggered when no victim UE may be present. To prevent resource misallocation, eICIC and HNIM functions may be triggered based on a WTRU informing an eNB that it is a victim UE.

In a first example, eICIC may be triggered on condition a victim UE is present and that the victim UE has informed the network of its victim status. In such a scenario, both the serving cell and the interfering cell may be made aware of the victim UE's presence. In the example illustrated in FIG. 3, the WTRU 302 may select Macro eNB 304 in order to inform Macro eNB 304 that it is causing interference for WTRU 302. WTRU 302 may report a proximity indication to Macro eNB 304, for example if WTRU 302 is configured to report proximity indications. The network may handover the WTRU 302 to Pico Cell eNB 306, which may serve a CSG cell. Macro eNB 304 also may collect measurements, for example measurements performed by Macro eNB 304, WTRU 302 and/or, Pico Cell eNB 306. Macro eNB 304 may be made aware that it can create interference to WTRU 302 and thus may take remedial measures and/or schedule its resources accordingly. Pico Cell eNB 306 may communicate to Macro eNB 304 downlink interference information using the network backhaul based on downlink measurements reported by WTRU 302. For example, Pico Cell eNB 306 may communicate the network backhaul information once WTRU 302 has been handed over to the Pico Cell eNB 306.

Such a procedure may not be applicable if the victim UE is unable to access on or more of the network cells causing the interference. For example, as shown in FIG. 2, WTRU 202 may be unable to access the Pico Cell eNB 306 due to its lack of membership in a CSG. Therefore, WTRU 202 may be unable to connect to Femto Cell eNB 206 in order to indicate victim status. Additionally, if Femto Cell eNB 206 was not deployed by a network operator, it may be difficult for Macro eNB 204 to identify Femto Cell eNB 206, making interference management techniques more difficult to implement. If the WTRU 202 is able to access the Macro eNB 204 despite the interference, WTRU 202 may send Macro eNB 204 a message indicating that Femto Cell eNB 206 is greatly interfering with reception of signals from Macro eNB 204. However, WTRU 202 may suffer radio link failure (RLF) to Macro eNB 204, and be unable to successfully send a message to Macro eNB 204 indicating WTRU 202's victim status. It is also possible that messages sent between Macro eNB 204 and Femto Cell eNB 206 may have extreme latency, which may lead to further negative consequences when attempting to indicate victim UE status.

In another example, interference caused by Femto Cell eNB 206 may cause WTRU 202 to be unable to properly receive paging messages from Macro eNB 204. In this example, WTRU 202 may not receive and respond to a paging message sent from Macro eNB 204, and thus be unable to properly connect to the core network, for example when WTRU 202 has an incoming voice call. Described below are methods for allowing a victim UE such as WTRU 202 to indicate that it is suffering from an interference situation and/or that it is a victim UE.

In order to conserve network resources while maintaining high levels of Quality of Service (QoS) for WTRUs deployed in heterogeneous networks, methods and system are described herein for determining and communicating the victim UE status of a WTRU experiencing interference. A WTRU may determine that it is a victim UE. Once the WTRU determines that it is a victim UE, the WTRU may inform its network serving cell and/or the interfering cell of its victim UE status. The WTRU may inform its serving cell of victim status in connected mode or in idle mode. Additionally, the WTRU may connect to an interfering CSG with permissions that exclude membership by the WTRU during a training period for the purpose of informing the CSG of the WTRU's victim status. The WTRU may inform a neighbor UE of its victim status, for example if it is experiencing RLF and is unable to connect to its serving cell and/or the interfering cell. Informing the serving cell and/or interfering cell may trigger an inter-cell interference management procedure such as eICIC or HNIM. Once the interference management procedure has is no longer required (for example, if the WTRU has moved to an area where the interference is no longer prohibitive), the WTRU may inform its serving cell, the interfering cell, or another cell (such as a neighbor cell), that the interference management procedures should be ended to conserve network resources.

Victim UE status may be determined based on interference being experienced by a WTRU. For example, if a WTRU is being served by a first cell (for example a cell with a Macro eNB), and interference is being caused by the eNB of a second cell (for example a Femto Cell deployed in the coverage area of the Macro eNB), the WTRU may determine that is a victim UE and may indicate its status accordingly. A WTRU that is a victim UE may be unable to connect to the cell causing the interference due to membership restrictions for the cell. For example, A WTRU may be connected to a Macro eNB. The WTRU may be in the vicinity of a femto cell or HeNB. The cell reselection criteria for the WTRU (for example RSRP measurements) may indicate that the femto cell is the strongest available cell or ranked higher than the current serving cell or the highest ranked cell during a time interval for the WTRU (e.g., the cell reselection criteria to the fempto cell may be met). However, if the femto cell eNB is broadcasting a CSG ID and the broadcast CSG ID is not located in the operator or white lists for the WTRU, the UE may assume that it is not a member of the femto cell. Therefore, the WTRU may fail to access the cell.

Alternatively and/or in addition to the above, the WTRU may continue to be served by the Macro eNB, which may be ranked lower in terms of cell reselection criteria than the femto cell eNB. The femto cell eNB may operate on the same or a similar frequency as the Macro eNB. The signal from the Macro eNB may be interfered with by the femto cell eNB. In this example, the WTRU may identify itself as a victim eNB. The determination by the WTRU of UE victim status may be based on measurements performed by the WTRU. For example, the WTRU may determine that an interference threshold has been achieved and/or exceeded, and thus victim UE status should be indicated. For example, the WTRU may determine that UE victim status has been achieved if the signal-to-interference plus noise ratio (SINR) falls below a threshold or is below a threshold. In another example, the WTRU may determine that victim UE status has been achieved where the RSRP of aggressor cell (for example a cell that is not the current serving cell for the WTRU and/or a cell which the WTRU is unable to connect to) exceeds a threshold or is above a threshold. For example, the threshold may be the current RSRP of the serving cell of the WTRU.

In an embodiment, a WTRU may use a proximity indication function to determine that it may be near a CSG cell and that it may be interfered with. The proximity indication may inform the serving cell for the WTRU that the WTRU is in the vicinity of a femto cell. In this case the proximity indication may be used to indicate that the WTRU is in the vicinity of a CSG cell that is not in its white list. The WTRU may indicate victim UE status when it sends the proximity indication. More specifically, the proximity indication may explicitly indicate that the CSG cell in the vicinity is not allowed to be accessed by the UE (e.g., the CSG ID is not in the white list for the WTRU). The WTRU may indicate victim status if it sends a proximity indication for a femto cell and it is unable to connect to the femto cell. In another example, if the Random Access Preamble Transmission to a serving cell for a WTRU (such as a Macro cell) has failed more than ‘n’ times, the WTRU may identify itself as a victim UE. The variable ‘n’ may be same as the Release-9 PreambleTransMax parameter or a new information element (IE). The value of n may be specified by the network or may be specific to the WTRU. In an embodiment, the WTRU may be connected and attached to a macro eNB, and if the WTRU is unable to decode a control channel and/or suffers Radio Link Failure, the WTRU may identify itself as a victim UE. In another example embodiment, a WTRU may implement idle mode procedures such as cell measurements and/or proximity indications while the WTRU is connected and attached to a Macro NB in order to determine victim UE status.

Once WTRU has determined that it may be a victim UE, the WTRU may indicate its presence to the interfering eNB. The interfering eNB may correspond to or serve a femto cell and/or CSG cell. The interfering eNB may further correspond to or serve a macro cell and interferes with a pico cell. The WTRU may be unable to access and/or connect to the interfering cell (e.g., a CSG cell). Methods are described herein to allow the UE to report its victim status to the network. In order to indicate its presence and victim UE status to the interfering cell, the WTRU may use a different WTRU to relay the message. For example a different WTRU may have access and/or permission to access the CSG cell. The WTRU with access to the CSG may be called a relay WTRU. The relay WTRU may be camped on or connected to the interfering femto cell. The relay WTRU may act as a relaying node to inform the femto cell of the presence of a victim UE. In another example, the WTRU may inform the user that it is in a high interference area and that it should perform manual selection on the interfering CSG cell(s).

The WTRU may also use the macro cell which it is camped on or connected to send an indication that a femto cell is interfering with the WTRU. In addition to the indication, the WTRU may send the macro cell eNB information regarding the identity and/or location of the femto cell causing the interference. For example, the WTRU may send the Physical Cell Identity (PCI) of the femto cell, the Cell ID of the femto cell, and or the CSG of the femto cell. The WTRU may send the macro cell other types of information which may be used to identify the femto cell causing the interference. For example, the information regarding the identity of the femto cell may be sent to the macro cell in a Radio Resource Control (RRC) Connection Request message and/or a RRC Connection Setup Complete Message.

In another example, the UE may send a victim UE status indication to the femto cell causing the interference. If the interfering femto cell is a CSG cell for which the WTRU does not have authorization o access or a proper subscription, it may be unable or unauthorized to initiate or attempt to perform a RRC connection to the CSG cell. However, the WTRU may be allowed to indicate its victim UE status to the femto cell without performing a full connection or registration to the femto cell. For example, the WTRU may determine based on its cell reselection criteria that the current CSG is the highest ranked cell and it meets the cell reselection criteria. When attempting to reselect to this cell, it may determine that it is unable to connect to the femto cell, for example because the WTRU lacks the requisite membership permissions. Despite the lack of membership in the CSG cell, the WTRU may send a RRC connection request to the eNB serving or corresponding to the femto cell. The WTRU may indicate in the RRC connection request message that the WTRU is a victim UE and/or that the femto cell is causing interference for the WTRU. For example, a new field in the RRC connection request message may be added that indicates the requesting WTRU is a victim UE.

A new establishment cause may be added in the RRC Connection request message. The victim status indication may signal to the femto cell and/or the network that the RRC connection request message was sent in order to indicate victim UE status of the WTRU. The WTRU may receive an RRC connection reject message from the femto cell eNB. The reception of the RRC connection reject message may be used by the WTRU to implicitly determine that the indication was successfully received by the network. Additionally, a new field may be added to the RRC Connection reject message to explicitly indicate that the indication of victim UE status was successfully received by the network. Upon reception of the RRC connection reject message the WTRU may move back to the macro cell to continue its normal procedures.

In another example, the WTRU may stop monitoring the femto eNB following the transmission of the RRC connection request which indicated victim UE status, and instead begin monitoring downlink (DL) paging channels of the macro eNB. In another example, the WTRU may send the indication in the RRC Connection setup complete message. In this example, the femto cell may have allowed access to the WTRU, for example without yet knowing that the WTRU is not a member and that it may be a victim UE; however, the WTRU may use the RRC connection setup complete message to indicate the victim UE status, after which it may receive a RRC Connection release from the CSG cell. The UE may further indicate in the RRC message the cell ID, PCI ID of the serving macro cell, to allow the femto cell to coordinate the eICIC pattern using the network backhaul. The capability that the femto cell supports reception of such RRC messages and these victim UE indications may be broadcasted in the System information of the femto cell.

If the WTRU momentarily switches from the Macro eNB to the femto eNB in order to send an RRC message indicating victim status to the femto cell, the WTRU may determine that certain cell reselection function are unnecessary since it will be returning to the macro cell shortly. For example, the WTRU may determine that it should not send a Tracking Area Update, Location Area Update, and/or Routing Area Update even though the femto cell has a Tracking Area, Location Area, and/or Routing area that may be different than the macro cell. In this example, from the prospective of the Non-Access Stratum (NAS) of the WTRU, the WTRU may still be considered connected and registered with the macro cell despite the communications with the femto cell.

In another example, in order for the WTRU to indicate its victim UE status to the femto cell, the WTRU may be granted temporary membership in the femto cell despite the CSG restrictions. For example, the WTRU may attempt to connect to the femto cell during a training period. For example, the training period may be indicated by the femto cell when it broadcast the Master Information Block (MIB). In another example, the femto cell may indicate temporary membership ability in SIB 1 (for LTE), in SIB 2/3 (for UMTS), and/or any other SIB. Temporary membership may allow the WTRU to access the cell for victim UE reporting and rather than for regular service. In another example, the temporary membership may make the femto cell a temporary hybrid cell, for example for a specified period of time. Upon being made aware of temporary membership, the WTRU may use several methods to indicate its presence.

For example, a common uplink channel may be introduced, where any WTRU may report and indicate its presence as victim UE. This channel may be common to WTRUs that attempt to report victim status. The report may be as simple as a burst, since it may be unnecessary to inform the femto cell causing the interference as to the identity of the victim UE; for example, the femto cell may be informed that a victim UE is present rather than the actual identity of the victim UE. In another example, the WTRU may indicate its identity to the femto cell. In addition, the femto cell may decide, based on the volume of victim UEs, whether to trigger eICIC and/or HNIM. This may help prevent undesirable situations where a large number of legitimate Femto UEs are harmed while simultaneously helping a relatively small number of victim UEs. For example, the femto cell may trigger an inter-cell interference management procedure if it receives a victim UE indication more than ‘m’ number of times for a specified time period. The value of the integer ‘m’ may be specified by the owner of the femto cell, by the network, and/or by another user. In another example, if multiple WTRUs indicate victim status during a specified time period, the femto cell may implement an inter-cell interference management procedure. The decision to initiate an interference management procedure may be based on the number of WTRUs which indicate victim UE status.

In another example, physical random access channel (PRACH) preamble(s) may be reserved for a WTRU to use to report its victim UE status indication. In this example, the WTRU may determine that continuation of the registration process after transmitting the preamble is unnecessary and may end the sequence prior to registration. In another embodiment, the reserved preamble(s) may be associated with specific PRACH resources in both frequency and/or time domain.

In an embodiment where the WTRU may have temporary membership, PRACH resources in both frequency and/or time domain may be reserved for a WTRU to use to report its victim UE status indication. In such a case, the WTRU may determine that continuation of the registration process after transmitting the preamble is unnecessary and may end the sequence prior to registration. In this alternative embodiment, the victim UE may use any common random access channel (RACH) access preamble.

In another example in which the WTRU has been granted temporary membership, an extra bit may be added to the RRC connection request message that indicates that the connection request is for victim UE indication. After transmission of the RRC connection request message, the WTRU may abort the RRC Connection process. In an embodiment where the WTRU has temporary membership, a new cause may be added to the WTRU femto cell/Home eNB registration procedure to indicate that the purpose of the registration attempt is to trigger eICIC (or HNIM). This may be added as a new establishment cause in the RRC Connection Request message (e.g., VictimUEIndication).

If a WTRU is connected and attached to a macro eNB when it detects the interference from a femto cell, the WTRU may inform the macro eNB that it is being interfered by femto cell. In such a case, the macro eNB may inform the MME that temporary membership to the CSG femto cell should be granted to the WTRU such that WTRU may select the CSG cell. Non-access stratum (NAS) signaling may be used to inform the WTRU that it has been granted temporary membership. In such a case, the WTRU may proceed with any of the methods described herein for indicating victim status using a temporary membership. In another embodiment the proximity indication function may indicate to the macro eNB that the WTRU may be in a high interference area. The macro eNB may inform the WTRU that it should attempt to register to the CSG femto cell. In such a case, the WTRU may proceed with any of the methods described herein for indicating victim status using a temporary membership. The victim status of the WTRU may be communicated to the MME via NAS signaling upon notification from the femto cell.

For example, if the WTRU uses the femto cell to send the victim UE status, during the time the WTRU is communicating with the femto cell, it may be unreachable by the network (e.g., for paging purposes), since the WTRU may be connecting and monitoring the CSG cell. In an effort to limit the paging interruption, the WTRU may initiate the signaling procedures to the femto cell, for example at the end of a paging occasion in the macro cell. This may give sufficient time to the WTRU to complete the communication with the femto cell between paging occasions. If the WTRU has insufficient time to report its victim status, then it may move back to the macro cell in the next paging occasion and stop DL reception in the CSG cell. In an alternate example, the WTRU may skip the next paging occasion, instead prioritizing the completion of the procedure/communication to the femto cell. In a different example, if the NAS is aware of the WTRU being granted temporary membership, it may use the CSG cell to page the WTRU even though the WTRU is not a member of the CSG cell. Upon reception of a paging information over a cell of which the WTRU is not a member, the WTRU may move back to the macro cell to initiate a RRC Connection in response to the page. Alternatively, the UE may use the page sent over the non-allowed CSG cell as an indication that it should move back to the macro cell to wait for the actual paging message to be sent over the macro cell.

In an embodiment, upon being informed by the WTRU that it may be experiencing interference from a CSG femto cell, the macro eNB may attempt Handover to the eNB for the femto cell. In the S1-AP (S1 application protocol) message, the macro cell may inform the femto cell eNB, for example a HeNB, that the purpose of the Handover request message may be to indicate the presence of a victim UE, rather than the initiation of an actual handover of the WTRU. In another embodiment, the WTRU may inform the MME directly through NAS signaling of its interference victim status so the core network (CN) can grant temporary membership to the WTRU for the CSG femto cell.

Note that in the situation in which a WTRU is given temporary membership status in order to access a CSG femto cell, the femto cell eNB may still perform a membership verification to determine the CSG membership status of the WTRU. If the WTRU is member of the CSG, the femto cell eNB may reply to an RRC Connection Request with an RRC Connection Setup message. In another example, the femto cell eNB may allow for Handover to occur if the WTRU is a member of the CSG and is in connected mode.

The CSG femto cell may decide to grant WTRU with a victim UE status visitor access to the CSG femto cell. Visitor status may allow the UE to use the CSG cell for regular services for a temporary amount of time or for a specified number of uses. For example, visitor status may allow a victim UE to connect to the CSG one time in order to report its victim UE status. Based on WTRU identity, the femto cell eNB may grant visitor access to the WTRU and communicate the grant of visitor status to the WTRU in an RRC message, for example an RRC connection setup message. The WTRU may also inform the femto cell eNB-Gateway and the network of such a temporary grant.

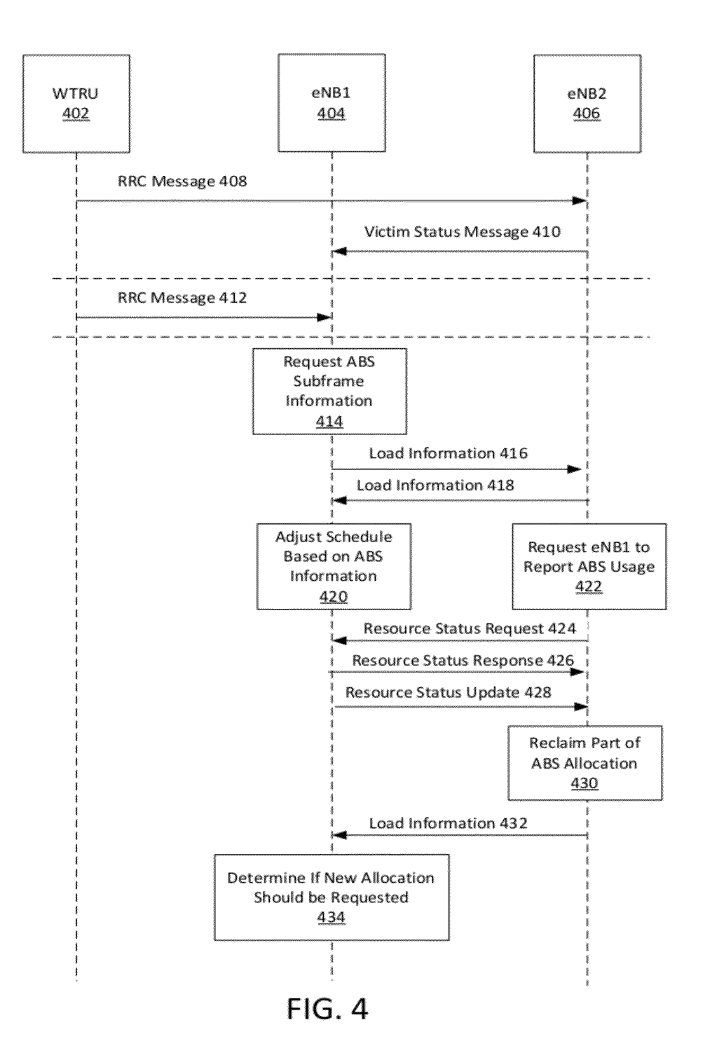

FIG. 4 illustrates an exemplary flow diagram for a WTRU which has determined that it may be a victim UE to indicate its victim UE status to the network and initiate an inter-cell interference management procedure. In this example, WTRU 402 may attempt to connect to, be connected to, be camped on, or be served by eNB1 404. eNB1 404 may be the eNB for a macro cell that serves an area in which WTRU 402 may be located. In another example, eNB 406 may be a HeNB or femto cell eNB in the vicinity of WTRU 402. eNB2 406 may be causing interference in the reception of messages from eNB1 404 to WTRU 402. For example, eNB2 406 may be a CSG femto cell located in the geographical area served by eNB 404. WTRU 402 may be unable to connect to eNB2 406 due to membership restrictions.

Once WTRU 402 has determined that it may be a victim UE, WTRU 402 may send RRC Message 408 to eNB2 406. Since WTRU 402 may be unable to connect to eNB2 406 due to membership restrictions, the RRC message may be sent for the purpose of indicating that the WTRU is a victim UE and/or that eNB2 406 is causing the interference. RRC Message 408 may include, without limitation, a WTRU Identity, the victim UE indication, and/or the cell global identification of eNB1 404 and/or eNB2 406. Although not shown in FIG. 4, eNB2 406 may optionally respond with an RRC connection reject message, an RRC connection setup message, an RRC connection release or the like, indicating that the victim UE indication has been properly received and/or indicating that a RRC connection establishment may be unnecessary or impermissible. eNB2 406 may then send Victim Status Message 410 to eNB1 404. Victim Status Message 410 may indicate that WTRU 402 has identified itself as a victim UE, that eNB2 406 may be causing the interference, and/or that WTRU 402 is attempting to connect to eNB1 404. Victim Status Message 410 may be an X2 interface application protocol (X2-AP) message, a Radio Network Subsystem Application Part (RNSAP) message, RNSAP User Adaption (RNA) message, or the like. In another example, Victim Status Message 410 may be an IP message, for example if eNB2 406 is a femto cell eNB such as a HeNB that a user has connected to the internet using a broadband connection. Victim Status Message 410 may include, without limitation, the WTRU Identity or context ID, the victim UE indication, and/or the cell global identification of eNB1 404 and/or eNB2 406. Upon receipt of Victim Status Message 410, eNB1 404 may being an inter-cell interference management procedure based on the receipt of the victim UE indication. Victim Status Message 410 may also include information from eNB2 406 to eNB1 404 to indicate that due to the victim UE indication, eNB2 406 has begun eICIC procedures and may include eICIC parameters (e.g., ABS pattern).

In another example illustrated by FIG. 4, rather than sending the RRC Message 408 to eNB2 406 in order to indicate its victim UE status, WTRU 402 may send RRC Message 412 to eNB1 404. RRC Message 412 may include, without limitation, a WTRU Identity, the victim UE indication, and/or the cell global identification of eNB1 404 and/or eNB2 406. Although not shown in FIG. 4, eNB1 404 may optionally respond with an RRC connection reject message, an RRC connection setup message, or the like, indicating that the victim UE indication has been properly received. Depending on network conditions and the severity of the interference caused by eNB2 406, WTRU may be able to successfully send RRC message 412 to eNB1 404. However, if the interference cause by eNB2 406 has caused a RLF between WTRU 402 and eNB1 404, victim UE status indication may be sent to eNB2 406, as is described with reference to RRC Message 408. In another example, WTRU 408 may send both RRC Message 408 and RRC Message 412 to ensure delivery of the victim UE status indication. In another example, WTRU 408 may first attempt to contact eNB1 404, but if WTRU 402 is unable to successfully relay the victim UE indication via eNB1 404, it may then attempt to contact eNB2 406 in order to relay the victim UE status indication. In another example, WTRU 408 may first attempt to contact eNB2 406, but if WTRU 402 is unable to successfully relay the victim UE indication via eNB2 406, it may then attempt to contact eNB1 404 in order to relay the victim UE status indication. In another example, the WTRU may indicate its victim UE indication to eNB1 404 and/or eNB2 406 through the various methods other than using an RRC message (e.g., proximity indication, temporary membership, etc.).

Once WTRU 402 has triggered the inter-cell interference management procedure by signaling a victim UE status indication to eNB1 404 and/or eNB2 406, eNB1 404 and/or eNB2 406 may begin an eICIC and/or HNIM procedure. For example, eNB1 404 may determine to Request Almost Blank Subframe (ABS) Subframe Information at 414. In another example, eNB1 404 may send allocated ABS subframe information which the eNB2 406 may use. The ABS subframe information may be used to determine on which subframes eNB2 406 may be broadcasting little to no data. eNB1 404 may use this information in order to schedule downlink delivery of data to WTRU 402 during subframes wherein eNB2 406 may be broadcasting little to no data. By broadcasting during these subframes, eNB1 404 may be able to minimize potential interference between eNB1 404 and eNB2 406. In another example, upon reception of the victim UE indication, eNB2 406 may launch eICIC and directly provide the ABS information to eNB1 404. In such a case, eNB2 406 may implicitly inform eNB1 404 of Victim Status and inform eNB1 404 of the eICIC parameters (e.g., ABS patterns).

eNB1 404 may send eNB2 406 Load Information 416, which may be a message requesting ABS subframe allocation and/or ABS information from eNB2 406. eNB2 406 may respond by allocating ABS subframes and providing the information to eNB1 404. eNB 406 may also respond by indicating that it has started using a specified ABS pattern. For example, eNB 406 may respond with Load Information 418, which may be a message indicating to eNB1 404 what ABS pattern is used. At 420, eNB1 404 may adjust its broadcast schedule in order to schedule data destined for WTRU 402 during the allocated ABS subframes. Optionally, at 422 eNB2 406 may request eNB1 404 to report its ABS subframe usage in order to allocate subframes efficiently. After activating a number of ABS subframes, eNB2 406 may make a periodic and/or aperiodic requests for ABS subframe usage status from eNB1 404 via Resource Status Request 424. eNB1 may respond with Resource Status Response 426, which reports on the usage of allocated ABS subframes by eNB1 404. Additionally, eNB1 404 may report ABS subframe usage to eNB2 406 at any time via a message such as Resource Status Update Message 428. Resource Status Response 426 and/or Resource Status Update 428 may include downlink ABS status information such as the percentage of ABS resources being used by eNB1 404 for victim UEs, unused ABS subframes (e.g., due to low load of victim UEs) and/or the like. Based on the reported usage of eNB1 404 and/or the transmission requirements of eNB2 406, at 430 eNB2 406 may determine that it should reclaim some or all of the ABS subframes. eNB2 406 may indicate a new ABS subframe allocation to eNB1 404 in a message, for example Load Information 432. Based on the new allocation of ABS patterns, at 434 eNB1 404 may determine that a new ABS subframe allocation should be requested in order to operably communicate with WTRU 402 in the downlink. If so, eNB1 404 may return to 414 and repeat the procedure to obtain a suitable allocation.

Some eICIC functions may require the coordination between a macro eNB and a femto cell eNB such as a HeNB. In an example, a WTRU may inform a macro eNB that it has declared itself a victim to the femto cell eNB. The WTRU may also inform the macro cell eNB that the WTRU has triggered eICIC and/or HNIM procedures. In order to ensure that the femto cell eNB has indeed triggered eICIC/HNIM, the femto cell eNB may indicate the successful triggering of eICIC/HNIM in a response to the WTRU. The response may be a single bit in the rejection of the UE's registration attempt (e.g., in the RRC Connection Reject message). In another example embodiment, for example when using a common uplink channel or a reserved PRACH preamble to indicate victim UE status, the femto cell eNB may broadcast its eICIC/HNIM status such that the WTRU may determine if the inter-cell interference management procedure was successfully triggered.

In another example, after receiving a victim UE status indication that triggers an inter-cell interference management procedure from a WTRU, a femto cell eNB may inform the macro eNB to which the WTRU is attempting to connect that the WTRU has indicated a victim UE status and/or that the femto cell eNB may be the source of the interference. The femto cell eNB may inform the macro cell eNB via X2-AP signaling, a RANSAP message, and/or an RNA message or the like. By indicating the identity of the WTRUs and the interfering femto cell eNBs to the macro eNB, the macro eNB may determine which WTRUs should be scheduled in ABS subframes and which may be scheduled during any resource.

Note that in the aforementioned solutions, the purpose of the communication by the WTRU with the femto cell eNB may be to inform the femto cell eNB of the presence of a victim UE. However, some eICIC/HNIM functions such as spatial beamforming may require more information from the victim UE and may call for periodic/non-periodic updates of the interference information and/or measurements. In such cases, the WTRU may update the CSG femto cell with interference information. The update may include, without limitation, the RSRP of one or more cells, a precoding matrix indicator (PMI) to serving cell of the WTRU, PMI orthogonal to precoder matrix used at the serving cell, and the like. In order to update a CSG femto cell with interference information, any of the aforementioned proposed methods may be repeated whenever the WTRU determines an update its interference measurements should be signaled to the CSG femto cell and/or when an interference measurement is requested by the macro eNB and/or femto cell eNB. For example, the measurement information may be include in an RRC message from the WTRU to an eNB or the WTRU may be given temporary membership in a CSG cell in order to report the interference measurements. The cause or the content of a femto cell access attempt may include the desired measurements for the chosen eICIC/HNIM function. Optionally, an RRC Connection Setup message may be sent to the WTRU and indicate that the WTRU has been granted access for measurement reporting.

In another example, the WTRU granted temporary membership into the CSG femto cell, and the membership may last for the entire time that the WTRU is classified as a victim UE. The WTRU may be able to update the CSG femto cell with interference information during the pendency of its temporary membership in the CSG. The membership for the WTRU during this period may be limited in manner, and the WTRU may access the CSG femto cell to report the interference measurements, but may have less than full access. For example, the WTRU may be unable to request user data from the via the CSG femto cell.

In another example for updating the CSG femto cell with interference information, the WTRU may use a common uplink channel to enhance its interference reporting with the updated measurements. In this example, the femto cell eNB may be unaware of the identity of the victim UE, but may be aware that inter-cell interference is occurring and that certain measurements are to performed and signaled to the femto cell via the common uplink channel. Therefore, it may be optional for the WTRU to identify itself when transmitting such reports.

In order to ensure the inter-cell interference management procedures such as eICIC or HNIM functions do not remain operational after the interference has been adequately addressed, a femto cell eNB and/or a macro eNB may be instructed to stop eICIC or HNIM functions by the WTRU. For example, to ensure the inter-cell interference management procedures are stopped, the femto cell eNB, the macro eNB and/or the WTRU experiencing the interference may include a timer, that when expired, signals that the inter-cell interference management procedure such as eICIC or HNIM should be terminated. However, upon expiration the WTRU may still be present and may still be classified as a victim UE. Therefore, the interference experienced by the WTRU may cause the WTRU to experience degradation in QoS or RLF. At such a point, WTRU may re-initiate an inter-cell interference management procedure in order to inform the CSG femto cell and/or macro cell that the WTRU is still present and may still be a victim UE.

In another example to ensure that eICIC, HNIM, or other interference management functions are terminated when they may longer be required, upon leaving the interfering zone, the WTRU may send a message indicating that it may be exiting the interference area. For example, the WTRU may use any of the described methods, and in addition to or in the place of the victim UE status indication, the WTRU may indicate that it may be leaving the interference zone. For example, a bit may be added to in a victim UE indication message which indicates a departure from the dead-zone. For example, an extra bit may be added in the RRC Connection Request message which corresponds to victim UE departing one or more of the affected cell coverage areas (e.g., the WTRU may report leaving the femto cell, the macro cell, or both). In addition, for the eICIC/HNIM functions for which the WTRU reports regular updates of its interference conditions, upon the femto cell eNB failing to receive an update a specified number of times consecutively, the femto cell eNB may elect to cancel the inter-cell interference procedure. The number of consecutive missed reports that triggers the termination of the interference procedure may be specified by the network or may be determined at the eNB and/or WTRU.

In another example, the macro eNB may stop an inter-cell interference procedure upon the departure of the WTRU or switch to idle mode by the WTRU. In another embodiment, if the WTRU remains connected and located in the same macro eNB cell but moves away from the interfering dead-zone, the WTRU may signal to the macro eNB that the interference has subsided. The notification may be included by adding a single bit to the WTRU interference measurement reports and/or may be include in another message to the macro eNB.

In an embodiment, the femto cell eNB may use a training period to determine the presence of a WTRU that may be a victim UE. In order for a femto cell eNB to broadcast the availability of a training period state, the femto eNB may indicate the Training Period state as a single bit in system information block 1 (SIB1) for LTE, or SIB 2/3 for UMTS, or in another SIB. In another example, a CSG Indication IE may be modified to have an extra bit to designate a femto cell eNB Training Period state.

In the example in which a CSG femto cell eNB may use a training period to determine the presence of a victim UE, if the CSG femto cell presents itself as a hybrid cell, upon being notified of WTRU registration attempt that includes a victim UE status indication, the network may respond with a registration reject message. An extra bit may be included to state that interference management such as eICIC and/or HNIM has been triggered. In another example, if the victim UE is in connected mode, the femto cell eNB may reject a handover request and add an extra bit informing a macro eNB that it is a CSG cell in Training Period. The indication may also inform the macro eNB that eICIC or HNIM may have begun. Support for UE victim status indication by the network may be configurable and signaled to a WTRU by SIBs and/or dedicated signaling such as RRC signaling, NAS signaling, and/or the like.

The methods for UE victim status indication may be configurable. The network may select a desired method and may signal it to the WTRU experiencing interference via SIBs and/or dedicated signaling such as RRC signaling, NAS signaling, and/or the like. In another example, the WTRU may autonomously select methods for reporting UE victim status. In another embodiment, the UE may negotiate the methods to use with the network. The methods disclosed herein may be used in any combination.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method comprising:
receiving, at a Wireless Transmit/Receive Unit (WTRU), a first transmission from a first eNode B (eNB), the first eNB corresponding a first cell;
determining that a second transmission from a second eNB is interfering with the first transmission from the first eNB, the second eNB corresponding to a second cell; and
sending a first message to at least one of the first eNB or the second eNB, wherein the first message indicates that the WTRU is experiencing interference and triggers a cell interference management procedure.

2. The method of claim 1, wherein the second cell is a closed subscriber group (CSG) cell, and the WTRU is not a subscriber to the CSG cell.

3. The method of claim 2, wherein determining that transmissions from a second eNB are causing interference with the transmissions from the first eNB comprises determining that cell reselection measurements indicate that the CSG cell is a higher ranked cell for the WTRU than the first cell during a time interval.

4. The method of claim 2, wherein determining that transmissions from a second eNB are causing interference with the transmissions from the first eNB comprises determining that a downlink channel reference signal received power (RSRP) of the second eNB is above a threshold.

5. The method of claim 1, wherein the first cell is a serving cell.

6. The method of claim 1, wherein the first message is a Radio Resource Control (RRC) message sent to the first eNB and includes at least one of a victim User Equipment (UE) indication, a physical cell identifier (PCI), cell identification (ID), or CSG ID of the second cell.

7. The method of claim 1, wherein the first message is a Radio Resource Control (RRC) message sent to the second eNB and includes at least one of a physical cell identity (PCI) of the first cell or a cell identification (Cell ID) of the first cell.

8. The method of claim 2, further comprising receiving an indication of temporary membership of the CSG cell in a system information block (SIB), wherein sending the first message to at least one of the first eNB or the second eNB comprises sending the message to the second eNB in accordance with the temporary membership.

9. The method of claim 1, wherein the message includes cell measurement information for the WTRU.

10. The method of claim 1, further comprising sending a second message to at least one of the first eNB or the second eNB, wherein the second message indicates the WTRU is no longer experiencing interference and terminates the cell interference management procedure.

11. A Wireless Transmit/Receive Unit (WTRU) comprising:
a receiver configured to receive transmissions from a first eNode B (eNB), the first eNB corresponding to a first cell;
a processor in communication with the receiver configured to determine that transmissions from a second eNB are causing interference with the transmissions from the first eNB, the second eNB corresponding to a second cell; and
a transmitter in communication with the processor configured to send a first message to at least one of the first eNB or the second eNB, wherein the first message indicates that the WTRU is experiencing interference and triggers a cell interference management procedure.

12. The WTRU of claim 11, wherein the second cell is a closed subscriber group (CSG) cell, and the WTRU is not authorized to connect to the CSG cell.

13. The WTRU of claim 12, wherein the processor is configured to determine that transmissions from a second eNB are causing interference with the transmissions from the first eNB by determining that cell reselection measurements indicate that the CSG cell is a higher ranked cell for the WTRU than the first cell during a time interval.

14. The WTRU of claim 12, wherein the processor is configured to determine that transmissions from a second eNB are causing interference with the transmissions from the first eNB by determining that a downlink channel reference signal received power (RSRP) of the second eNB is above a threshold.

15. The WTRU of claim 11, wherein the processor is configured to determine that transmissions from a second eNB are causing interference with the transmissions from the first eNB by determining that the WTRU is unable to decide a control channel or that the WTRU has suffered radio link failure.

16. The WTRU of claim 11, wherein the first message is a Radio Resource Control (RRC) message sent to the first eNB and includes at least one of a physical cell identifier (PCI), cell identification (ID), or CSG ID of the second cell.

17. The WTRU of claim 11, wherein the cell interference management procedure is an enhanced Inter-Cell Interference Coordination (eICIC) procedure.

18. The WTRU of claim 17, wherein the eICIC procedure employs at least one of power control, time-domain resource partitioning, frequency-domain resource portioning, or spatial beamforming.

19. The WTRU of claim 12, wherein the receiver is further configured to receive an indication of temporary membership of the CSG cell in a system information block (SIB), wherein the transmitter is configured to send the first message to at least one of the first eNB or the second eNB by sending the message to the second eNB in accordance with the temporary membership.

20. The WTRU of claim 11, wherein the transmitter is further configured to send a second message to at least one of the first eNB or the second eNB, wherein the second message triggers termination of the cell interference management procedure.

21. A method implemented by a first eNode B (eNB), the method comprising:
receiving a first message from a Wireless Transmit/Receive Unit (WTRU) indicating that the WTRU is experiencing interference due to transmissions from the first eNB and a second eNB; and
initiating a cell interference management procedure based on the first message.

22. The method of claim 21, wherein the cell interference management procedure comprises:
requesting Almost Blank Subframe (ABS) subframe pattern information from the second eNB; and
transmitting data to the WTRU based on the ABS subframe pattern information.

23. The method of claim 22, wherein transmitting data to the WTRU based on the ABS subframe pattern information comprises transmitting data to the WTRU during periods in which the second eNB is not transmitting.

24. The method of claim 22, wherein the cell interference management procedure comprises:
allocating Almost Blank Subframe (ABS) subframe pattern information from to the second eNB; and
transmitting data to the WTRU based on the ABS subframe pattern information.

25. The method of claim 21, wherein the cell interference management procedure is an enhanced Inter-Cell interference Coordination (eICIC) procedure or a Home Node B Interference Management (HNIM) procedure.

26. The method of claim 25, wherein the eICIC procedure or the HNIM procedure employs at least one of power control, time-domain resource partitioning, frequency-domain resource portioning, or spatial beamforming.
